(19) United States
(12) Patent Application Publication
(10) Pub. No.: US 2010/0229227 A1
(43) Pub. Date: Sep. 9, 2010

(54) Online authentication system

(76) Inventors: Luc Andre, Gattieres (FR); Alain Cadio, Carros (FR); Michiel Fast, Macqueville (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/660,074

(22) Filed: Feb. 18, 2010

Related U.S. Application Data
(60) Provisional application No. 61/208,021, filed on Feb. 18, 2009.

(51) Int. Cl. H04L 9/00

(52) U.S. Cl. 726/6; 726/3

(57) ABSTRACT

A hardware device connected to a network access point to authenticate itself to a server is disclosed. The device stores authentication software, and applicative data. The device is used to generate a one-time password to uniquely identify itself to a server.

### REFERENCE TO RELATED APPLICATION

This application claims priority to U.S. Provisional Application No. 61/208,021, filed Feb. 18, 2009.

### FIELD OF THE INVENTION

The invention relates to the field of authentication, and in particular to a hardware device implementing authentication.

### PRIOR ART

Internet is used to perform a growing number of critical tasks, such checking emails, paying bills, online trading, and managing bank accounts. All these critical tasks require a user identification, but most often, this authentication is poorly performed using a login name/password pair. Once maliciously obtained using phishing, spy-ware techniques, or other means, the login/password pair can provide access to your identity and private information.

Protecting software against illegal copy usage is a also major issue in the computer industry. But most often copy protection is performed using serial numbers enforced in a software only solution. Serial number protection system is not secure since serial numbers can be propagated using peer to peer networks and are readily found on many web sites.

A uniquely identifiable hardware key that can be authenticated but that can't be copied would solve the user authentication and software protection issues.

### BRIEF DESCRIPTION OF THE DRAWINGS

FIG. 1 is a diagram illustrating how a remote web server can authenticate a user using the present invention.

FIG. 2 is a flow diagram illustrating the steps associated with the authentication of the present invention.

FIG. 3 is a flow diagram illustrating the steps associated with the protection of software.

### DETAILED DESCRIPTION

An authentications server and method are described for providing a means to uniquely identify a remotely connected hardware device. The hardware device can be compared to a physical key which allows its owner to gain access to secured web pages. As a direct extension, the device can of course be used to validate and authorize use of software. In the following description, numerous specific details are set forth such as specific connectors and implementing steps. It will be apparent to one skilled in the art, that the present invention may be practiced without these specific details. In other instances, well-known software code and other details are not described in detail in order to not unnecessarily obscure the present invention.

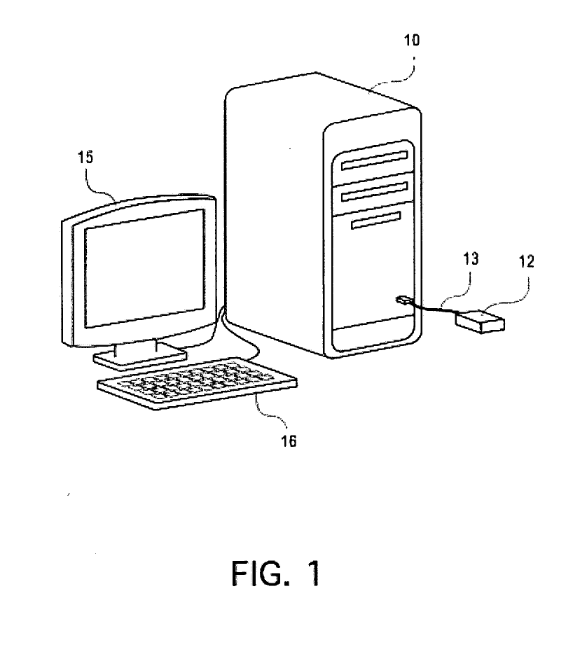

Referring first to FIG. 1, a computer system is illustrated having a central processing unit (CPU) 10, a display 15, keyboard 16, and the device 12. The device 12 of the present invention is illustrated connected within a cable 13. The cable 13 connects the CPU 10 with the device 12. Any software or service for which online authentication is needed, may employ the device 12.

While in FIG. 1 the device 10 is shown as being a computer, the device 10 may be any device connected to a network, hereafter to be referred to as a network access point, such as a phone.

While in FIG. 1 the device 12 is shown as being connected into the cable 13, the device 12 may be embedded within a connector which connects to the network access point, or a wireless device which communicates with the network access point using any short-distance wireless connection method.

In practice, the device 12 receives power for its operation from the network access point. Power may be provided on dedicated lines, or the power may be phantom fed over communication lines. The device 12 may alternatively receive power from its own power source.

As will be discussed, when the device is connected to the network access point 33, the network access point can operate the device to perform authentication services.

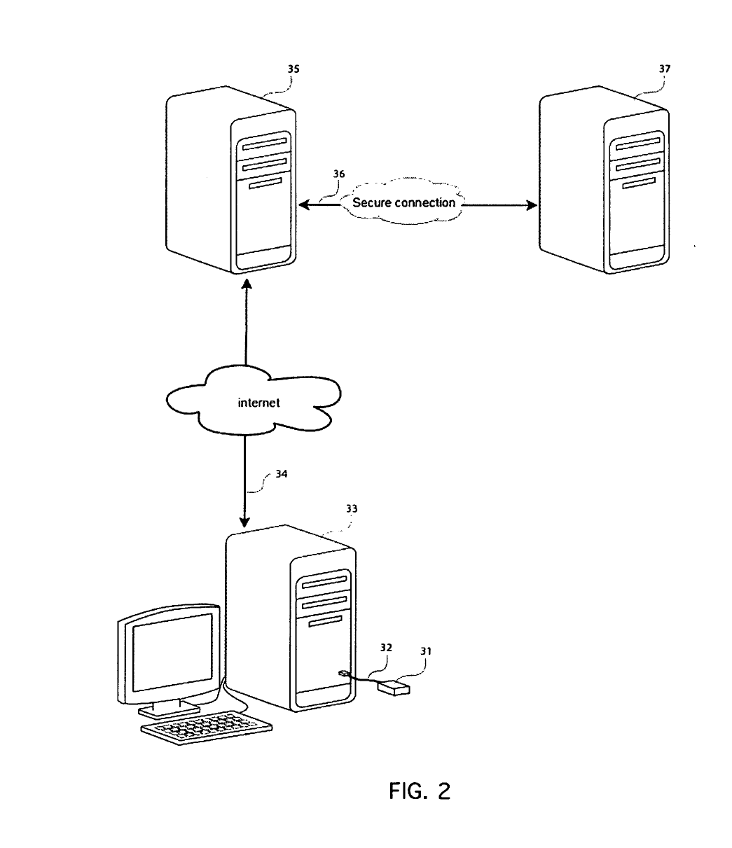

Referring to FIG. 2, the server 35 that wants to provide secure access to its information or services, requests the public unique identification stored in the device 31 connected to the network access point 33.

The server 35 requests a random token from the authentication server 37, which is forwarded to the network access point 33.

The network access point 33 transmits the random token to the device 31 in order for the device to calculate a one-time password. This computed one-time password is sent to the server 35 for validation.

The server 35 forwards this one-time password, along with the random token and the public unique identifier of device 31 to the authentication server 37 for validation. Once the authentication server 37 confirms the validity of the one-time password, the server 35 is guaranteed that the uniquely identified hardware device 31 is effectively connected to the network access point 33. At this time access to the application, web service, or other protected service can be granted.

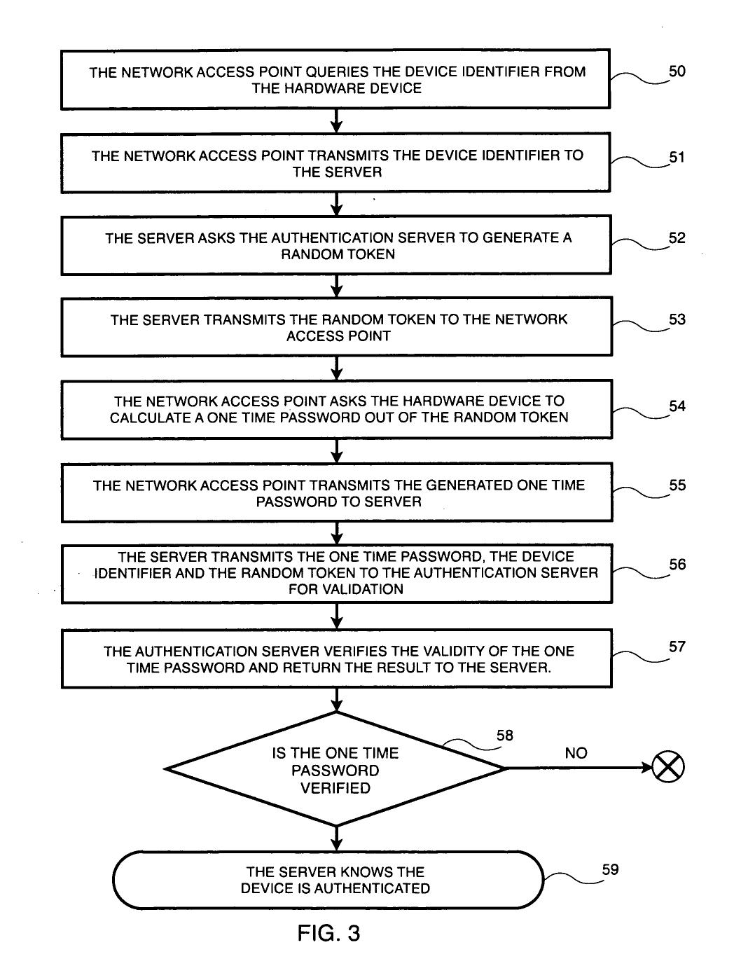

Referring to FIG. 3, the operation of the device of FIG. 1 is described. At step 50, the network access point reads the public unique identification from the hardware device 12 of FIG. 1, which is connected to the host USB port of the computer such as the CPU 10 of FIG. 1.

The network access point 33 of FIG. 2 transmits the device's public unique identifier to the server 35 of FIG. 2, as indicated in step 51.

As indicated by step 52 the server 35 of FIG. 2 asks the authentication server 37 of FIG. 2 to generate a random token.

The server transmits the random token returned by the authentication server to the network access point, as indicated in step 53.

The network access point asks the hardware device to generate a one-time password. It does this by providing the random token to the hardware device, which in return transmits the computed one-time password. This is indicated by step 54.

The network access point transmits the generated one-time password to the authentication server, as indicated at step 55.

The server transmits the one-time password, the public unique identification, and the random token for validation to the authentication server. This is indicated be step 56.

The authentication server verifies the validity of the one-time password, and returns the result to the server, as indicated in step 58.

As indicated by step 59, at this stage the server knows if the uniquely identified hardware device 12 of FIG. 1 is effectively connected to the network access point 10 of FIG. 1.

What is claimed is:

1. A system comprising:
a hardware device connected to a network access point; an authentication server that is able to authenticate the hardware device; and a server that wants to check that the hardware device is effectively connected to the network access point.

2. The system of claim 1, wherein the hardware device is connected to the network access point using any kind of wired or short-distance wireless interface.

3. The system of claim 1, wherein the hardware device contains a unique public identifier (at least 4 bytes long).

4. The system of claim 1, wherein the authentication server is able to generate random tokens (at least 4 bytes long), which are valid only during a short time (at most 10 seconds).

5. The system of claim 1, wherein the hardware device is able to generate a one-time password (at least 4 bytes long) based on a random token and its unique identifier using a non-disclosed algorithm.

6. The system of claim 1, wherein the authentication server is able to verify that a random token is valid.

7. The system of claim 1, wherein the authentication server is able to verify that a one-time password was generated using a given random token and the unique public identifier of the hardware device.

8. The system of claim 1, wherein the server can be located on the network access point or on a remote server.

9. The system of claim 1, wherein the server is able to communicate with the authentication server and the network access point.
